(19) United States
(12) Patent Application Publication
(10) Pub. No.: US 2024/0115359 A1
(43) Pub. Date: Apr. 11, 2024

(54) FULL ARCH 3D DIGITAL FACIAL SCANNING WORKFLOW ECOSYSTEM FOR SURGERY AND RESTORATION OF DENTAL IMPLANTS

(71) Applicants: Frank Charles Pope, III, Tracy, CA (US); Larry Stites, Tracy, CA (US)

(72) Inventors: Frank Charles Pope, III, Tracy, CA (US); Larry Stites, Tracy, CA (US)

(73) Assignee: FI3LD DENTAL SOLUTIONS, Tracy, CA (US)

(21) Appl. No.: 18/378,449

(22) Filed: Oct. 10, 2023

Related U.S. Application Data
(60) Provisional application No. 63/415,176, filed on Oct. 11, 2022.

(51) Int. Cl. A61C 9/00; A61C 8/00

(52) U.S. Cl. CPC A61C 9/0006; A61C 8/0001; A61C 9/0053

(57) ABSTRACT

The design can be implemented in a 3D patient full arch digital workflow and workflow parts. The workflow of parts can include a STV tray. The STV tray that has a frame with a U-shaped opening resembling a bite shape of the teeth in a patient's mouth. The U-shaped opening is located in the frame of the STV tray where the teeth of the patient should be located. The frame has lips and walls to structurally form and support dental putty inserted into the U-shaped in the frame as well as secure the dental putty in place when removing the STV tray from the patient's mouth. The STV tray in cooperation with the dental putty and one or more universal scan bodies is engineered to keep blood, debris, and moisture out of a scanning field of an intraoral scanner while capturing a dental impression of a dental implant's position and an accurate tissue topology adaptation under compression.

### RELATED APPLICATION

This application claims priority to and the benefit of under 35 USC 119 of U.S. provisional patent application titled “A 3D PATIENT FULL ARCH DIGITAL WORKFLOW AND WORKFLOW PARTS,” filed Oct. 11, 2022, Ser. No. 63/415,176, which is incorporated herein by reference in its entirety.

### FIELD

Embodiments of the disclosure generally relate to a 3D patient full arch digital workflow and workflow parts for dental procedures and dental surgeries.

More particularly, an aspect of an embodiment relates to a 3D model scanner to model a patient's face with scannable implant parts used in a 3D patient full arch digital workflow.

### BACKGROUND

Dental surgeries and surgical techniques could benefit from AOX closed flap digital workflows, that is, where the patients' gums are completely sutured for safety, ease of scanning and increased accuracy. However, current methods for full arch digital workflow are a complicated and costly process. Moreover, some conventional scanning methods during surgery are performed with an open flap which involves unsound surgical practices such as injecting addition-curing silicone for bite registration in an open flap.

### SUMMARY

Provided herein are some embodiments. In an embodiment, the design is directed to a 3D patient full arch digital workflow and workflow parts. An aspect of an embodiment relates to a STV tray that has a frame with a U-shaped opening resembling a bite shape of the teeth in a patient's mouth. The U-shaped opening is located in the frame of the STV tray where the teeth of the patient should be located. The frame has lips and walls to structurally form and support dental putty inserted into the U-shaped in the frame as well as secure the dental putty in place when removing the STV tray from the patient's mouth. The STV tray in cooperation with the dental putty and one or more universal scan bodies is engineered to keep blood, debris, and moisture out of a scanning field of an intraoral scanner while capturing a dental impression of a dental implant's position and an accurate tissue topology adaptation under compression.

These and other features of the design provided herein can be better understood with reference to the drawings, description, and claims, all of which form the disclosure of this patent application.

### BRIEF DESCRIPTION OF THE DRAWINGS

The multiple drawings refer to the example embodiments of the design.

FIG. 1A illustrates a side view of a diagram of an embodiment of a STV tray with a U-shaped frame with walls and holes in the walls as well as with a U-shaped opening resembling a bite shape of the teeth in a patient's mouth.

FIG. 1B illustrates a top down view of a diagram of an embodiment of a STV tray with a U-shaped frame with a U-shaped opening located in a middle of the U-shaped frame of the STV tray where the teeth of the patient should be located.

FIG. 1C illustrates a perspective view of a diagram of an embodiment of a STV tray that has a U-shaped frame to receive the dental putty material to capture a dental impression so a scan of where each of the implants should be embedded, and the dental putty captures a tissue topology of a patient's mouth in a compressed state in the dental impression in the dental putty as well as provides an accurate location of each implant for the scan.

FIG. 2A illustrates a side view of a diagram of external surfaces of an embodiment of an orientation scan marker that is a component in the set of parts used in a full arch 3D digital facial scanning workflow.

FIG. 2B illustrates a side view of a diagram of internal surfaces of an embodiment of an orientation scan marker that accepts a screw into the top of the component as well as has a hex head to screw in the orientation scan marker itself into the patient's bone.

FIG. 3A illustrates a side view of a diagram of internal surfaces of an embodiment of an orientation scan marker with an example length of 6 millimeters.

FIG. 3B illustrates a side view of a diagram of internal surfaces of an embodiment of an orientation scan marker with an example length of 12 millimeters, where the orientation scan marker is available in different thread pitches and dimensions because of the location they go inside the mouth.

FIG. 4A illustrates a perspective view of a diagram of external surfaces of an embodiment of a universal scan body to have two or more distinct shapes in an exterior of a top portion of the STV tray to be able to pick out points of commonality to stitch different scans together.

FIG. 4B illustrates a side view of a diagram of internal surfaces of an embodiment of a universal scan body to have a hollow interior to allow threads of a screw to pass through the first universal scan body and then screw into a cavity in a top of 1) a scan nug, 2) a multi-unit abutment, 3) an orientation scan marker, and 4) a scan bullet.

FIG. 4C illustrates a side view of a diagram of external surfaces of an embodiment of a universal scan body to mate to multiple other components in a set of parts used in a full arch 3D digital facial scanning workflow consisting of 1) a scan nug, 2) a multi-unit abutment, 3) an orientation scan marker, and 4) a scan bullet, depending on a procedure being performed in a surgery stage for the dental implants or a restoration stage for the dental implants in the full arch 3D digital facial scanning workflow.

FIG. 5A illustrates a side view of a diagram of internal surfaces of an embodiment of a scan bullet having an internal cavity to receive a screw passing through a universal scan body to capture an accurate dental putty impression.

FIG. 5B illustrates a perspective view of external surfaces of an embodiment of a scan bullet to be placed in an implant site in the dental impression captured by the universal scan body locked into position in the dental putty that has hardened.

FIG. 6A illustrates a side view of a diagram of internal surfaces of an embodiment of a suture cap having an internal cavity to receive a screw that can screw into a multi-unit abutment/analog during surgery.

FIG. 6B illustrates a perspective view of external surfaces of an embodiment of a suture cap to allow the doctor to suture the tissue around the suture cap.

FIG. 7A illustrates a side view of a diagram of internal surfaces of an embodiment of a scan nug with an internal cavity to receive a screw from a universal scan body.

FIG. 7B illustrates a perspective view of external surfaces of an embodiment of a scan nug that has notches/indents on opposite sides to aid in establishing points of commonality to locate in a scan image.

FIG. 8 illustrates a side view of a diagram of internal surfaces of an embodiment of a universal scan body mated to an orientation scan marker.

FIG. 9 illustrates a side view of a diagram of internal surfaces of an embodiment of a universal scan body mated to a scan bullet.

FIG. 10A illustrates a side view of a diagram of external surfaces of an embodiment of a multi-unit analog used in the full arch 3D digital facial scanning workflow ecosystem for surgery and restoration of dental implants.

FIG. 10B illustrates a perspective view of a diagram of external surfaces of an embodiment of a multi-unit analog.

FIG. 10C illustrates a side view of a diagram of internal surfaces of an embodiment of a multi-unit analog.

FIG. 11 illustrates a side view of a diagram of internal surfaces of an embodiment of a universal scan body mated to a suture cap that is mated to a multi-unit analog.

The additional documents and drawings submitted with this document show further example parts and ways to implement this concept and design.

While the design is subject to various modifications and alternative forms, specific embodiments thereof have been shown by way of example in the drawings and will herein be described in detail. The design should be understood to not be limited to the particular forms disclosed, but on the contrary, the intention is to cover all modifications, equivalents, and alternatives falling within the spirit and scope of the design.

### DETAILED DISCUSSION

In the following description, numerous specific details are set forth, such as examples of specific data signals, named components, number of wheels in a device, etc., in order to provide a thorough understanding of the present design. It will be apparent, however, to one of ordinary skill in the art that the present design can be practiced without these specific details. In other instances, well known components or methods have not been described in detail but rather in a block diagram in order to avoid unnecessarily obscuring the present design. Further, specific numeric references such as a first implant, can be made. However, the specific numeric reference should not be interpreted as a literal sequential order but rather interpreted that the first implant is different than a second implant. Thus, the specific details set forth are merely exemplary. Also, the features implemented in one embodiment may be implemented in another embodiment where logically possible. The specific details can be varied from and still be contemplated to be within the spirit and scope of the present design. The term coupled is defined as meaning connected either directly to the component or indirectly to the component through another component.

The 3D patient full arch digital workflow and a set of workflow parts has many features, and some example features will be discussed below. In general, an embodiment discussing the full arch 3D digital facial scanning workflow ecosystem for surgery and restoration of dental implants and the set of workflow parts will be discussed as an example embodiment.

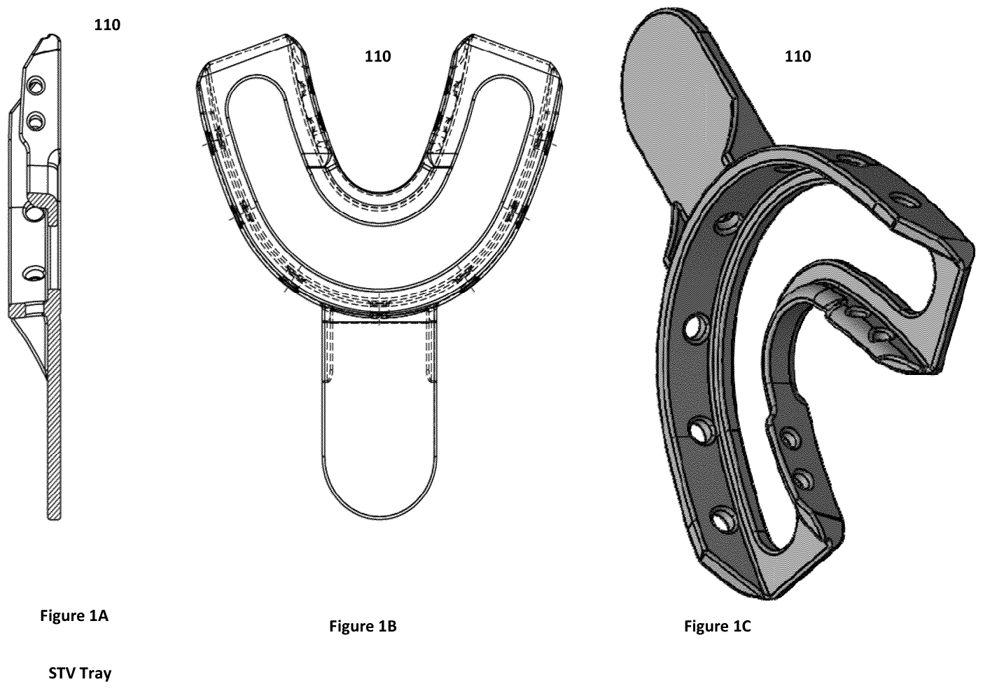

FIG. 1A illustrates a side view of a diagram of an embodiment of a STV tray 110 with a U-shaped frame that has walls with holes as well as a U-shaped opening resembling a bite shape of the teeth in a patient's mouth. FIG. 1B illustrates a top down view of a diagram of an embodiment of a STV tray 110 with a U-shaped frame with a U-shaped opening located in a middle of the U-shaped frame of the STV tray 110 where the teeth of the patient should be located. FIG. 1C illustrates a perspective view of a diagram of an embodiment of a STV tray 110 that has a U-shaped frame to receive the dental putty material to capture a dental impression so a scan of where each of the implants should be embedded, and the dental putty (e.g. bonding material) captures a tissue topology of a patient's mouth in a compressed state in the dental impression in the dental putty as well as provides an accurate location of each implant for the scan.

The Scan, Tissue, Verification (STV) tray in cooperation with the dental putty, one or more universal scan bodies 115, and other components in a set of parts is engineered to keep blood, debris, and moisture out of a scanning field of an intraoral scanner while capturing an accurate dental impression of each dental implant's position and an accurate tissue topology adaptation under compression. The U-shaped frame has lips and walls to structurally form and support the dental putty (e.g., bonding material) inserted into the U-shaped opening and into the holes in the walls of the U-shaped frame. The lips, walls, and holes in the walls secure the dental putty in place when removing the STV tray 110 and its frame from the patient's mouth. Thus, the lips and walls of the U-shaped frame of the STV tray 110 provide a surface for the dental putty (e.g. bonding material) to adhere to as well as the multiple holes in the sides/walls allow the dental putty to fill into these holes, which allows the dental putty material to lock into the frame of the STV tray 110 during removal of the STV tray 110 from the patient's mouth as well as when subsequent scans occur on the STV tray 110 with the universal scan bodies 115. The STV tray 110 with the dental putty gives the ability to capture a dental impression which can then be removed from the mouth to get a scan outside the bloody environment of the anatomy of the mouth including the tissue topology under compression and preserve the tissue topology under compression during the 3D scan. The height of the walls of the frame are short to accommodate a moderate amount of dental putty in the frame of the STV tray 110 and be anatomically contoured while not forcing the lengths of the other components in the system to be longer. The frame of the STV tray 110 has a tongue extending outward from a patient's mouth located in a center of the frame to assist with the STV tray 110 and dental putty removal from the mouth while maintaining the integrity of the captured dental impression.

The STV tray 110 allows for uses with 3 different functions 1) scanning (more accurately by optimizing the scanning condition because the universal scan bodies 115 are embedded in the dental impression material hardened within the frame of the STV tray 110 and eliminates blood & debris.), tissue (the dental impression also captures the tissue topological state under compression), and verification (because the universal scan body are down tight against the suture cap or MUA, embedded in putty, the need for a verification jig is no longer needed. Thus, the multiple purpose STV tray 110 cooperates with the universal scan bodies 115 and the dental putty to provide a tool for i) a 3D digital facial scan, ii) a collection of a tissue impression of the tissue topology under compression, as well as iii) a verification of acceptable locations for the dental implants, all in one component, which is used during the pre-surgery stage, the surgery stage for the dental implants, as well as the restoration stage for the dental implants. The STV tray is also utilized for a quick and accurate alignment of the files.

The STV tray 110 provides a frame for the dental putty material to capture a dental impression so a scan of where each of the dental implants should be embedded, and the puddy/impression material captures the tissue of a patient's mouth in a compressed state in the impression in the bonding material as well as provides an accurate location of each implant for the scan. Note, the same STV tray 110 can be used during the pre-surgery stage, the surgery stage, and the restoration process.

In general, the full arch 3D digital facial scanning workflow ecosystem for surgery and restoration of dental implants and workflow parts uses sequential parts which are connected to a digital library. The sequential parts are designed to be interchangeable and to give versatility affordability, some reusability, and ease of use to the doctors, during complex “All on X” (AOX) surgical procedures to strategically place implants to support a full arch of replacement teeth. Dental Implants (e.g., multiple unit analogs) can be as minimal as a single tooth replacement or can incorporate 4 or up to 10 implants. The full arch 3D digital facial scanning workflow ecosystem for surgery and restoration of dental implants can be an AOX surgical procedure. The All on X treatment concept refers to supporting all teeth with however many implants are required. This workflow was designed to be utilized with a closed flap (where the patients' gums are completely sutured) which is the preferred surgical techniques with leading surgeons. A surface treatment, such as sand blasting the surface, on the set of parts (including the universal scan body 115, the scan nug 133, the scan bullet 122, and suture cap 118) allows for accurate scanning while our threaded screw connection allows for easy inter-changeability of parts depending on the clinical situation.

The facial scanner the workflow was especially designed for the dental patient in a dental environment. The full arch 3D digital facial scanning workflow ecosystem for surgery and restoration of dental implants uses a 3D model scanner to 3D model the patients face.

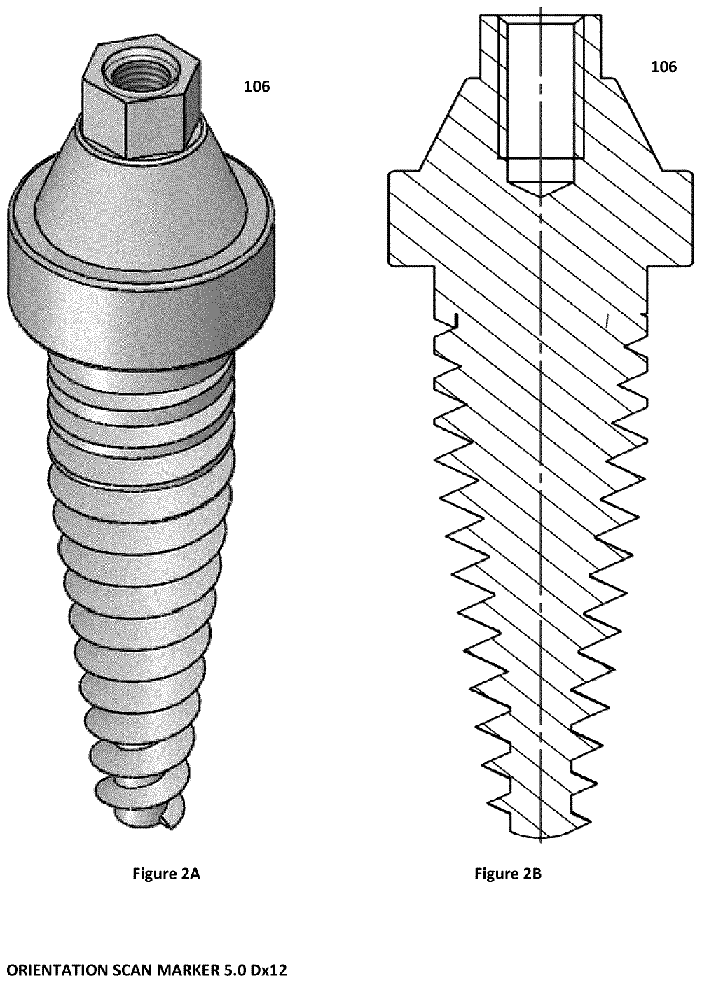

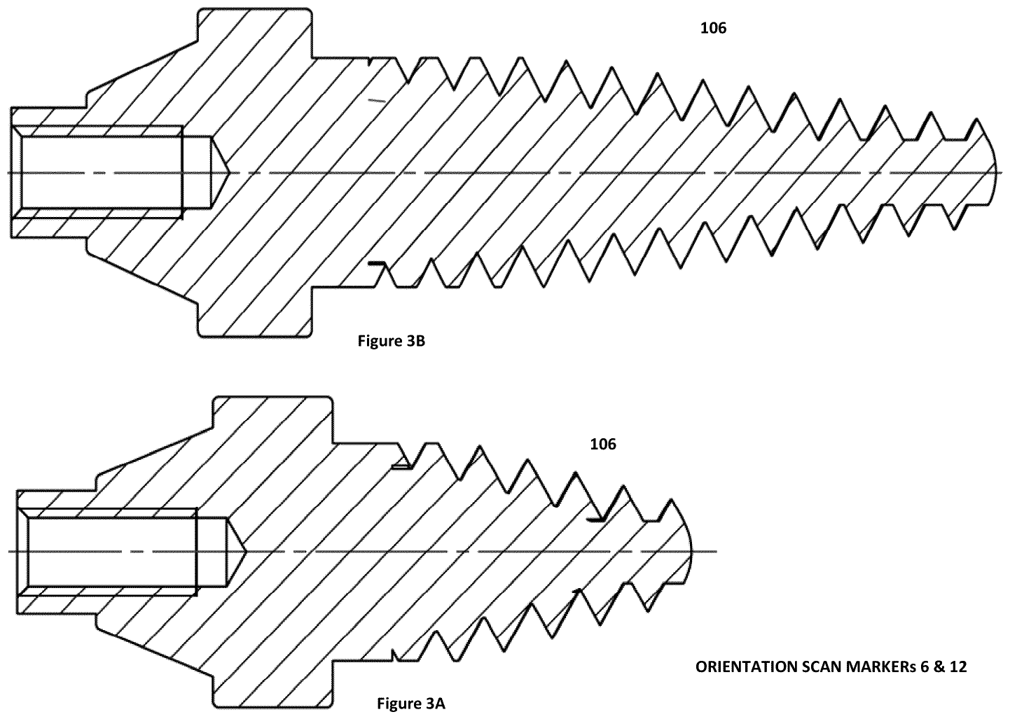

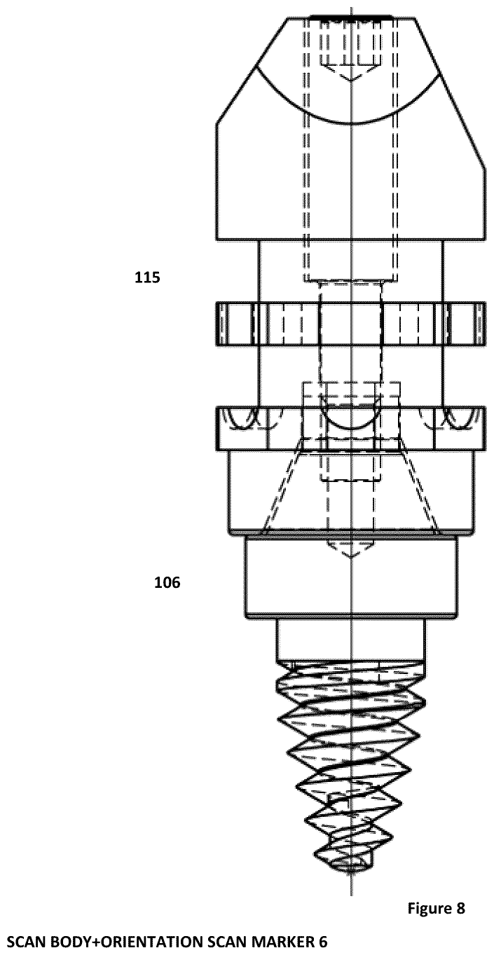

FIG. 2A illustrates a side view of a diagram of external surfaces of an embodiment of an orientation scan marker 106 that is a component in the set of parts used in a full arch 3D digital facial scanning workflow. FIG. 2B illustrates a side view of a diagram of internal surfaces of an embodiment of an orientation scan marker 106 that accepts a screw into the top of the component as well as has a hex head to screw in the orientation scan marker 106 itself into the patient's bone. FIG. 3A illustrates a side view of a diagram of internal surfaces of an embodiment of an orientation scan marker 106 with an example length of six (6) millimeters. FIG. 3B illustrates a side view of a diagram of internal surfaces of an embodiment of an orientation scan marker 106 with an example length of twelve (12) millimeters, where the orientation scan marker 106 is available in different thread pitches and dimensions because of the location they go inside the mouth. FIG. 8 illustrates a side view of a diagram of internal surfaces of an embodiment of a universal scan body 115 mated to an orientation scan marker 106 with the screw seating within the universal scan body 115 and screwing into the internal cavity of the orientation scan marker 106.

The orientation scan marker 106 accepts a screw into the top of the component as well as has a hex head to screw in the orientation scan marker 106 itself into the patient's bone. The orientation scan marker 106 is available in different thread pitches and dimensions. The pitch of the of the thread of the orientation scan marker 106 is tight with small gaps between threads/has a high pitch and a wide diameter of the component itself. The orientation scan markers 106 come in three different lengths 6, 8, and 12 mm because of the location they go inside the mouth into the bone so it could be in, for example, the palate. So, the doctor has a variation of heights to place the orientation scan markers 106 based on each surgery. The different lengths give them the option depending on the region of the facial anatomy, that the doctor is going to place the marker in situations that require a longer screw and in some situations that require a shorter screw depending on the anatomy. The orientation scan markers 106 also change the pitch of screw when shorter so that you have more grip. Thus, the, for example, three different sizes and shapes of the orientation scan marker 106 are designed to screw into the bones of patient's mouth in different portions of the mouth. Also, the geometry at the head of orientation scan marker 106 is such that a doctor can apply enough torque on the head to screw into the bone of the patient.

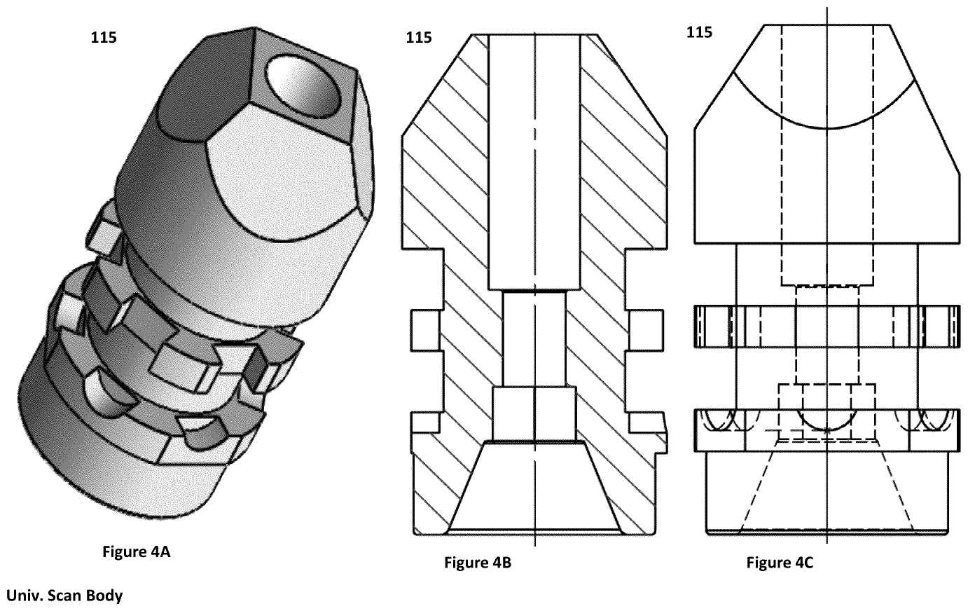

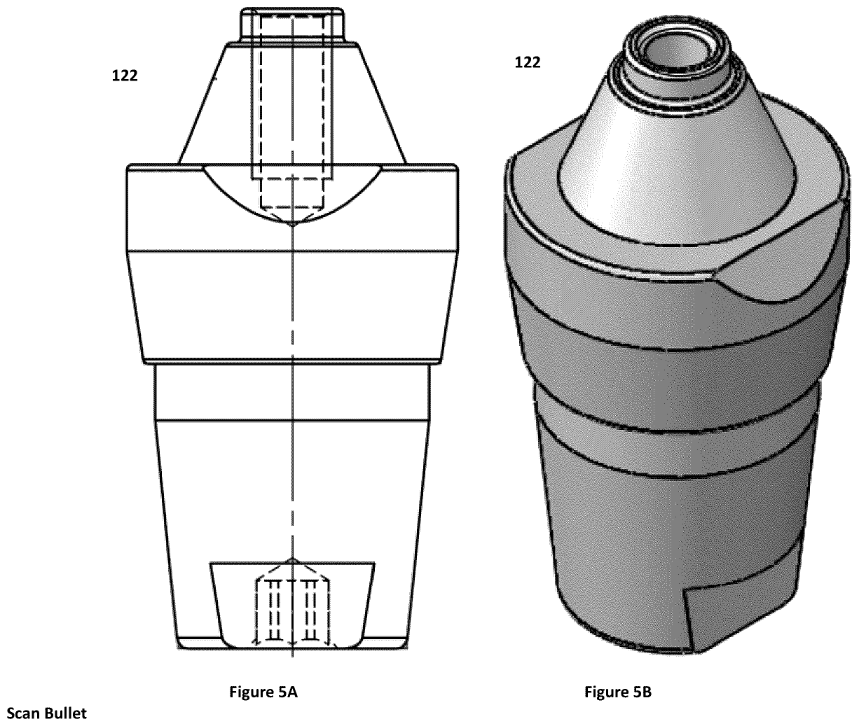

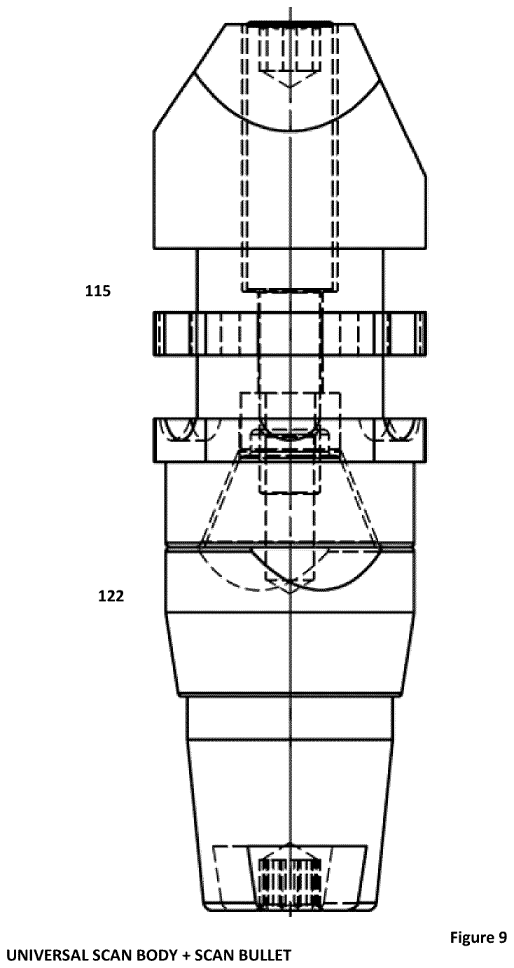

FIG. 4A illustrates a perspective view of a diagram of external surfaces of an embodiment of a universal scan body 115 to have two or more distinct shapes in an exterior of a top portion of the STV tray 110 to be able to pick out points of commonality to stitch different scans together. When two different scan images share points of commonality in the two scans, then they can be stitched together along the points of commonality. FIG. 4B illustrates a side view of a diagram of internal surfaces of an embodiment of a universal scan body 115 to have a hollow interior to allow threads of a screw to pass through the first universal scan body 115 and then screw into a cavity in a top of 1) a scan nug 133, 2) a multi-unit abutment 126, 3) an orientation scan marker 106, and 4) a scan bullet 122. FIG. 4C illustrates a side view of a diagram of external surfaces of an embodiment of a universal scan body 115 to mate to multiple other components in a set of parts used in a full arch 3D digital facial scanning workflow consisting of 1) a scan nug 133, 2) a multi-unit abutment 126, 3) an orientation scan marker 106, and 4) a scan bullet 122, depending on a procedure being performed in a surgery stage for the dental implants or a restoration stage for the dental implants in the full arch 3D digital facial scanning workflow. FIG. 5A illustrates a side view of a diagram of internal surfaces of an embodiment of a scan bullet 122 having an internal cavity to receive a screw passing through a universal scan body 115 to capture an accurate dental putty impression. FIG. 5B illustrates a perspective view of external surfaces of an embodiment of a scan bullet 122 to be placed in an implant site in the dental impression captured by the universal scan body 115 locked into position in the dental putty that has hardened. FIG. 9 illustrates a side view of a diagram of internal surfaces of an embodiment of a universal scan body 115 mated to a scan bullet 122.

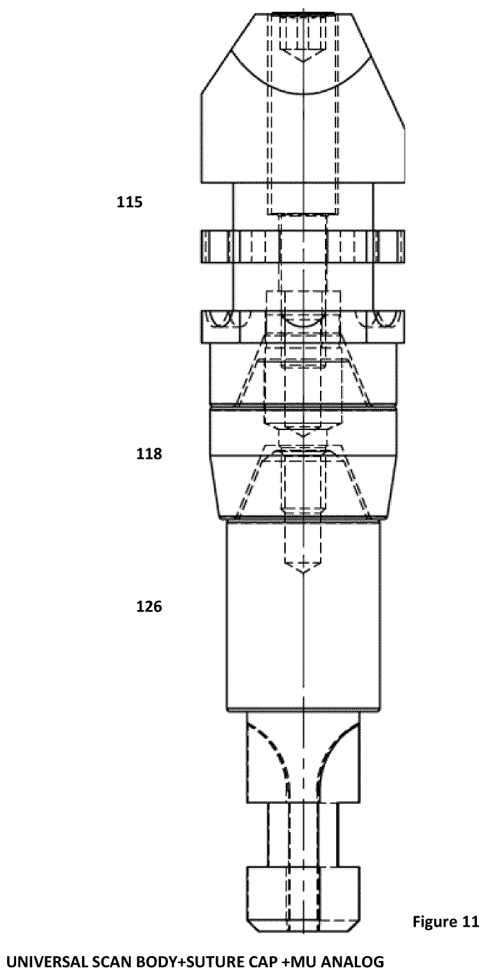

The set of parts (e.g., a STV tray 110, multiple different dimensions of orientation scan markers 106, a universal scan body 115, a scan bullet 122, a suture cap 118, a scan nug 133, a multi-unit abutment 126, threaded screws, etc.) were designed to give versatility to the doctors, depending on the clinical situation they find themselves in. The parts are interchangeable to simplify the process. The parts were also designed to be sequential, which means that the parts fit on top of each other, in a logical order, without having to be removed or exchanged constantly. See, for example, FIG. 8, FIG. 9, and FIG. 11 of the universal scan body 115 mating with a screw into various other components, suture cap 118, multiple unit abutment 126, scan bullet 122, etc., in the set of parts. Most of the parts can be screwed on with and withdrawn a driver. If the doctor wants to use a driver to torque different components in the set of parts, the doctor can choose the 0.050 driver head, which is the most common driver style in the dental industry. All components in the set of parts are integrated to a digital library, both their internal and external surfaces, which are then used to align surgical scans into the designed process after the surgery has been completed and before the final restorative steps are started.

Some of the components in the set of parts can be re-used in different stages of a full arch surgery and restoration process in the dental field. Full-arch implants typically use a series of 4-6 dental implants to restore an entire arch of missing teeth. Once these implants have been placed and have healed, the dentist will make a set of permanent or removable implant-supported dentures that screw onto the implants (e.g., multiple unit analogs).

Again, the set of parts include, a STV tray 110, multiple different dimensions of orientation scan markers 106—for example, 6 mm, 8 mm, and 12 mm orientation markers, a universal scan body 115, a scan bullet 122, a suture cap 118, a scan nug 133, a multi-unit abutment 126, threaded screws, etc. These parts may allow the surgeon to take all necessary scans with a closed flap unlike prior techniques that do the scanning step with an open flap.

Using the full arch 3D digital facial scanning workflow ecosystem allows closed flap surgery allowing sound surgical practices, while avoiding injection of addition-curing silicone for bite registration that is used in open flap surgery. The full arch 3D digital facial scanning workflow ecosystem controls workflows and revenue stream with a simple and very limited procedure avoiding costly and unnecessarily complex procedures.

The versatility in the full arch 3D digital facial scanning workflow ecosystem is through use of scannable threaded connections, easy inter-changeability of parts depending on the clinical situation, scannable parts that have a unique surface treatment for ease of scanning and increased accuracy, and use of a STV tray 110 which allows the doctors to scan in a bloody and wet environment also with a closed flap. Most of these parts can be screwed on with and without a driver, for example, a 0.050 driver head, which is the most common driver style in the dental industry.

The sequential parts, which are connected to our own digital library, were designed to be interchangeable and to give versatility affordability, some reusability, and ease of use to the doctors, during complex AOX surgical procedures. Again, the full arch 3D digital facial scanning workflow ecosystem surgical procedure for dental implants can be as minimal as a single tooth replacement or can incorporate 4 or up to 10 implants that supports all of the teeth with however many implants are required. The full arch 3D digital facial scanning workflow ecosystem was designed to be utilized with a closed flap (where the patients' gums are completely sutured) which is the preferred surgical techniques with leading surgeons. A surface treatment to lessen the reflectivity of the surface of a component during a scan allows for accurate scanning while the threaded connection allows for easy inter-changeability of parts depending on the clinical situation.

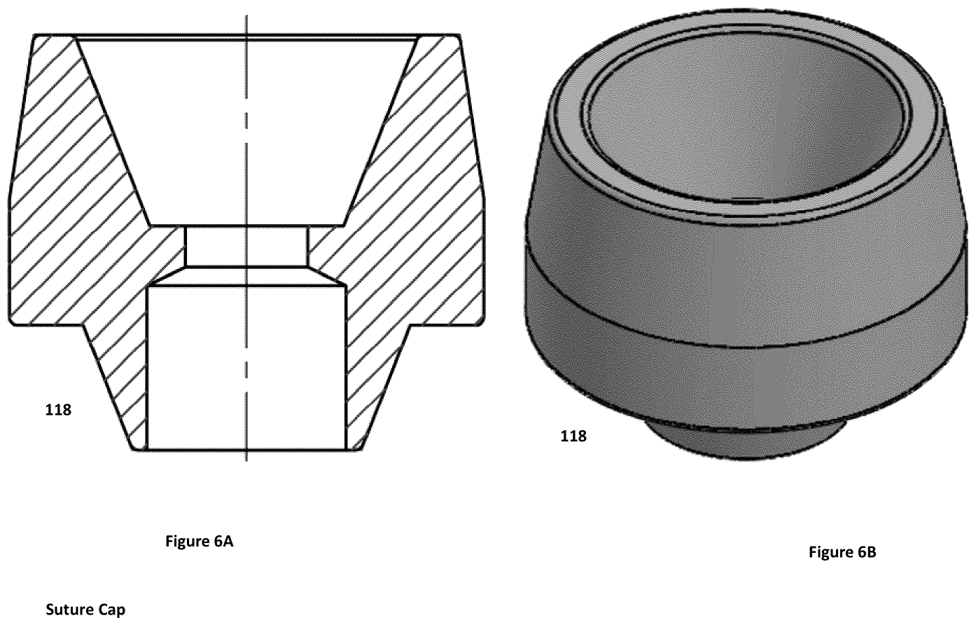

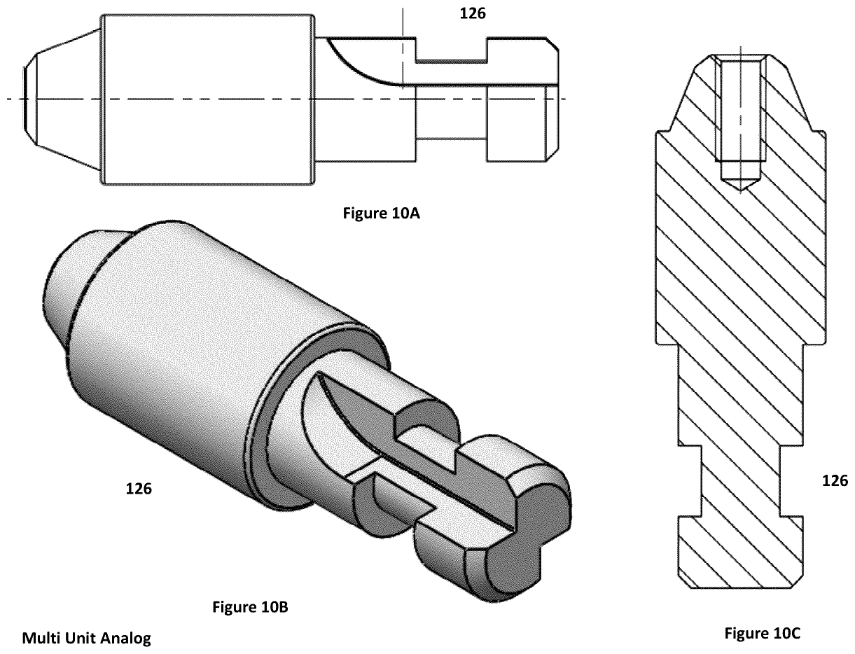

FIG. 6A illustrates a side view of a diagram of internal surfaces of an embodiment of a suture cap 118 having an internal cavity to receive a screw that can screw into a multi-unit abutment/analog 126 during surgery. FIG. 6B illustrates a perspective view of external surfaces of an embodiment of a suture cap 118 to allow the doctor to suture the tissue around the suture cap 118. FIG. 10A illustrates a side view of a diagram of external surfaces of an embodiment of a multi-unit abutment 126 (e.g., a dental implant replica) used in the full arch 3D digital facial scanning workflow ecosystem for surgery and restoration of dental implants. FIG. 10B illustrates a perspective view of a diagram of external surfaces of an embodiment of a multi-unit abutment 126. FIG. 10C illustrates a side view of a diagram of internal surfaces of an embodiment of a multi-unit abutment 126. FIG. 11 illustrates a side view of a diagram of internal surfaces of an embodiment of a universal scan body 115 mated to a suture cap 118 that is mated to a multi-unit abutment 126.

The full arch 3D digital facial scanning workflow ecosystem for surgery and restoration of dental implants allows the capture of the implant position in a simplified, accurate way in both during the surgery stage and during the restorative phase. The other thing the full arch 3D digital facial scanning workflow ecosystem for surgery and restoration of dental implants does is the dental impression gives this ability to capture the tissue under compression. The full arch 3D digital facial scanning workflow ecosystem for surgery and restoration of dental implants reduces significant appointments the surgery and restoration of dental implants process. Overall, the full arch surgery and restoration system for dental implants eliminates many steps in the implant dental implant process. The full arch 3D digital facial scanning workflow ecosystem for surgery and restoration of dental implants allows doctors to utilize this workflow with existing technologies, i.e., inter oral scanners.

In an example method for the full arch 3D digital facial scanning workflow ecosystem can be below. Please note more or less steps may be performed than the shown steps. In addition, where logically possible, the steps may be performed in an order than the example listed order. The example method for the full arch 3D digital facial scanning workflow ecosystem may include the surgery stage and the restorative stage.

Surgery

During the surgery phase, the doctor may place the one or more orientation scan markers 106 in different locations, such as the palate, before tooth extractions. The doctor may place the scannable orientation marker (e.g., screw into a bone) in the palate for the maxilla, as well as place a scannable orientation marker in the posterior and/or anterior region for the mandible.

Next, the doctor may place the universal scan body 115 onto the hex shaped head of the orientation scan marker 106 and hand tighten the two parts together with the screw that passes through the universal scan body 115 and screws into a cavity in the top of the orientation scan marker 106. Note, the hex shaped cavity in the universal scan body 115 allows the universal scan body 115 to seat direct against the top surfaces of the orientation scan marker 106, the scan bullet 122, etc., without worrying about tissue or blood interfering or coming between that seating when the universal scan body 115 is secured in the mouth.

The doctor can scan the upper jaw with the universal scan bodies 115 in place. In an embodiment, the full arch 3D digital facial scanning workflow ecosystem for surgery and restoration of dental implants may use an Obiscanner to acquire a 3D model of the patient's face. Other facial scanners could also be utilized with this workflow. The 3D model scanner used for this workflow is the entry way to augmented reality in the dental field. The 3D facial scanner together with the associated set of parts can be utilized in many 3D AOX workflows.

Next, the doctor can perform tooth extractions as needed and install the dental implants as needed. The doctor performs the surgery following their preferred technique and utilizes the implant system of their choice. The doctor places the dental implants (e.g., the multi-unit abutments/analogs 126) in the mouth of the patient.

Next, the doctor install suture caps 118. The doctor screws the suture cap 118 into a corresponding multi-unit abutment/analog 126. Note, the suture cap 118 is not threaded but instead is secured with a screw through its body to the multi-unit abutment 126. Importantly, blood and tissue could lock up a threaded suture cap 118 and then unscrew other parts such as the multiple unit analog later rather than merely the suture cap 118 itself. Thus, a threaded suture cap 118 was eliminated for one that is hollow to have a separate screw pass through and secure to the multi-unit abutment 126. Once the suture cap 118 is placed and secured, then the doctor can suture the tissue around the suture cap 118.

Next, the doctor sutures the tissue of the patient. The full arch 3D digital facial scanning workflow ecosystem for surgery and restoration of dental implants and the set of parts can be utilized with a closed flap (where the patients' gums are completely sutured) which is the preferred surgical techniques with leading surgeons. The methodology and STV tray 110 can be used in closed flap full arch digital replacement and its multiple stages of (the initial IOS scan, the full arch surgery, and the full arch restoration stages). The full arch 3D digital facial scanning workflow ecosystem for surgery and restoration of dental implants utilizes the STV tray 110 and rest of the parts, which allows the doctor to obtain accurate scans from the bloody and wet environment of a closed flap surgery. The full arch 3D digital facial scanning workflow ecosystem for surgery and restoration of dental implants uses material designed to be utilized in a closed flap procedure.

Next, the doctor can install universal scan bodies 115 onto the suture caps 118. The doctor screws on the universal scan body 115 onto a corresponding suture cap 118. After the surgery and placement of suture cap 118 onto multiple unit abutment/analog, then the suture caps 118 have been installed and the tissue around those suture caps 118 has been sutured, then the doctor installs the universal scan bodies 115 on to the suture caps 118 as well as a universal scan body 115 is put onto the orientation scan marker 106 installed/located in the palette.

Next, the empty STV tray 110 is placed in the patient's mouth. The doctor checks to verify that each of the universal scan bodies 115 in the bite of the patient extends through the U-shaped opening in the frame of the STV tray 110 and protrudes above the STV tray 110. All scan areas must be above the STV tray 110. The doctor may make minor adjustments to the STV tray 110 or other components if necessary. If the universal scan bodies 115 do not fit in the tray, the doctor will have issues with the screw channel, alignments, accessibility to the screw channel, an unwanted screw channel position in the aesthetic zone, extra cantilever forces onto the implant, or other complications. Thus, the doctor can put in both an upper STV tray 110 and a lower STV tray 110 and verify the universal scan bodies 115 connected to suture caps 118 both fit within the U-shaped opening between the frame of the STV tray 110 and extend above the STV trays 110. Next, with the universal scan bodies 115 installed, the doctor can scan the jaw.

Next, the doctor can remove the STV tray 110 from the mouth. The doctor can take the dental putty material and put the dental putty material into the STV tray 110. The dental putty fills in the area of the U-shaped opening in between the frame of the dental tray. The holes built into the walls of the frame of the STV allow the dental putty to pass through those holes, and then lock in and hold the putty in place, the holes are also important for the alignment of implant scan and tissue scan supported and held in place by the rest of the frame. The doctor will then push the STV tray 110 through the universal scan bodies 115, remove excess material, make sure to create a bridge between the STV tray 110 to the orientation scan marker 106(s) installed in the mouth, remove blood and putty off the universal scan bodies 115 with some gauze, and remove the dental putty from the screw access holes. Thus, the doctor places the STV tray 110 with the putty material into the patient's mouth and presses the STV tray 110 and putty material into place around the installed universal scan bodies 115 connected to the suture caps 118, which will extend past both the wall of the STV tray 110 and the dental putty material contained in the frame of the STV tray 110. Once the dental putty material has set, the doctor removes any debris from each of the installed universal scan bodies 115. Now the doctor can start the scan free of blood and loose tissue with the putty in place and the universal skin bodies within the dental putty in place.

Thus, the doctor allows the dental putty to harden. The doctor verifies that the area is clean and dry, and then starts the IOS scanning of the positions of the dental implants indicated by the universal scan bodies 115. Once the doctor is done with the IOS scanning of the positions of the dental implants indicated by the universal scan bodies 115, the doctor can, QC, the scan data that the sequence of scans is clean and verify that no data is missing, and verify that none of the universal scan bodies 115 disappeared while rendering. Thus, the doctor has verified that there is no need to over scan the patient's mouth.

Note, some of the parts, the universal scan body 115, the scan bullet 122, the suture cap 118, and the scan nug 133 have their exterior surfaces sandblasted so that they are not highly reflective during the scan, (e.g., not reflective enough to create blurs or blind spots in the resulting scan). The high reflectivity can cause issues with an intraoral scanner interpreting what is being scanned when making its 3D model, and thus, the external surface being sand blasted is configured to allow the 3D facial scan to accurately interpret a presence and location of the one or more universal scan bodies 115 in the 3D facial scan. Note, the components are also sized in dimensions to work with most facial scanners. The universal scan body 115, the scan bullet 122, the suture cap 118, and the scan nug 133 have dimensions sized to work with oral 3D scanners that merely have an optical scanning range of 5 millimeters of depth to facial scanners that can have a 12 millimeter facial scanning depth. Thus, the components fit size wise into an oral scanner's camera's depth of field. The camera's depth of field can be, for example, about 5 to 6 millimeters in height. Thus, what portions of the components, such as the universal scan body 115 and the scan nug 133, sticks out above the dental putty impression material is 5 millimeters in height or less. Thus, the component dimensions in the full arch 3D digital facial scanning workflow ecosystem optimize the performance of the camera of the oral scanner by only really needing to scan the 5 to 6 millimeters. Whereas if the system did not have this STV tray 110 and hardened putty capturing that impression, then the universal scan body 115 can be 12 millimeters long, and the optical scanner is never going to be able to get an accurate scan because the camera's depth of field compared to the scanned components are off.

Next, the doctor can embark on steps to remove the STV tray 110 with its hardened putty and unscrew the universal scan bodies 115 locked in the dental impression from the suture caps 118. The doctor can unscrew everything and remove the STV tray 110 from the patient's mouth. The universal scan body 115 is locked in place in the dental putty in the frame of the STV tray 110 that has been removed from the patient's mouth. The universal scan body 115 is configured to have multiple retention prongs that are in a middle portion of its body that lock the first universal scan body 115 into the dental putty to prevent the first universal scan body 115 from rotating once the dental putty hardens in the STV tray 110.

Next, the doctor can rinse the removed STV tray 110.

Next, the doctor can install one or more scan bullets 122 and perform a tissue scan with the scan bullets 122 installed. The doctor can place scan bullets 122 in each dental implant site in the impression, which is captured by the universal scan body 115 locked into position in the hardened putty. The doctor can dry the impression and parts thoroughly and then scan with the IOS scanner. The STV tray 110 with the putty captures the dental impression of where the dental implants are installed in the patient's mouth.

The universal scan body 115 is on one side of the dental putty impression and the scan bullet 122 is on the other side of the dental putty impression, which is locked into the STV tray 110. In the software library, those are merged into one common piece to be able to make accurate determinations on alignment of the implant, because the technician merging scans and making determinations from the scans can choose from both ends, as well as an amount of tissue in the mouth.

Note, the bottom portion of the scan bullet 122 has a similar shape and geometry to the scan nug 133. The top portion of the scan bullet 122 has a similar shape and geometry to the suture cap 118. The scan bullet 122 along with the dental impression captured in the dental putty that has hardened allows a capture of a tissue scan of the tissue topology under compression. Thus, the topography of the tissue around the dental implant is captured under compression, without all of the blood and debris present during surgery.

The scan nug 133 and the bottom portion of the scan bullet 122 have a notch/indent on opposite sides to aid in establishing points of commonality to locate in a scan image. The notch provides an accurate reference point for commonalty between two scans being stitched together for alignment and orientation during the restoration stage. The full arch 3D digital facial scanning workflow ecosystem for surgery and restoration of dental implants cooperates with facial scanners and advanced algorithms to seamlessly transition to a fully digital workflow.

The STV tray 110 with the dental putty captures both the locations of the dental implants, as well as the topography of the tissue around the dental implants. The scan bullets 122 along with the dental impression captured in the hardened dental putty allows the capture of the tissue scan. Again, the topography of the tissue around the dental implant is captured under compression. The tissue scan is captured under pressure which provides an accurate gingiva adaptation. Note, when the doctor presses the STV tray 110 with the dental putty down, the putty material squishes down to tissue as well as captures the shape of the bone. During surgery, generally the tissue is swollen, and the doctor has no idea where the bone is located. But when the doctor presses this dental impression material (putty) down it basically squishes all tissue and captures the ridge so know the shape of the bone. Thus, with the STV tray 110 out of the patient's mouth, the doctor can place the scan bullets 122 into one side of where the dental implant will go. The doctor can screw the scan bullets 122 into the universal scan body 115 which is locked in place in the putty in the frame of the STV tray 110, and then scan the putty impression with the scan bullet 122 connected to the universal scan body 115 with the putty capturing the tissue topography. Note that the tissue topography is captured under pressure. The universal scan bodies 115 are on one side of the dental putty impression and the scan bullet 122 is on the other side of the dental putty impression still in the STV tray 110. The top side of the STV tray 110 with the putty material has the universal scan bodies 115 removed from the patient's mouth protruding from that side. The bottom of the STV tray 110 has both the topological impression of the tissue of the patient's mouth formed in the dental impression captured by the putty as well as scan bullets 122 protruding through that bottom side to provide the location and angle of the implant installed in the patient's mouth. The scan bullet 122 is connected to the universal scan body 115 via a screw passing through the body of the universal scan body 115 into an awaiting threaded connection within the body of the scan bullet 122.

Next, once the doctor has verified that the scan is accurate, then post process the scan and send to the laboratory. The multiple unit abutment/analog is left in the patient's mouth with the healed tissue. The full arch 3D digital facial scanning workflow ecosystem for surgery and restoration of dental implants works with a dental scanner to capture the scans of where any teeth and capture the positions of where the implants should be in a simple accurate way using reflections and the absence of blood and tissue in order to get a very accurate recordation of where those implants should be. In a surgical situation, the scan of the dental impression in the STV tray 110 with the scan makers and other components capture where there are incisions, where the surgical tissue is location, and is able to digitize that tissue relative to the installed parts and patient's dental anatomy where so the doctor does not have to guess where the tissue is, and the scan cooperating with the STV tray 110 is able to capture the impression of the surgical tissue in a dry, non-bloody environment. And the result is that when the technician makes a temporary dental implant or the final restoration dental implant under these conditions with that STV tray 110 and the dental impression captured in the dental putty, the locations and angles where the implants will go as well as tissue topology when these dental implants will be installed will be very accurate.

Next, the patient goes home with a temporary denture if the doctor has a 3D printer in the office or the laboratory delivers the temporary denture subsequently to the doctor's office.

Restoration

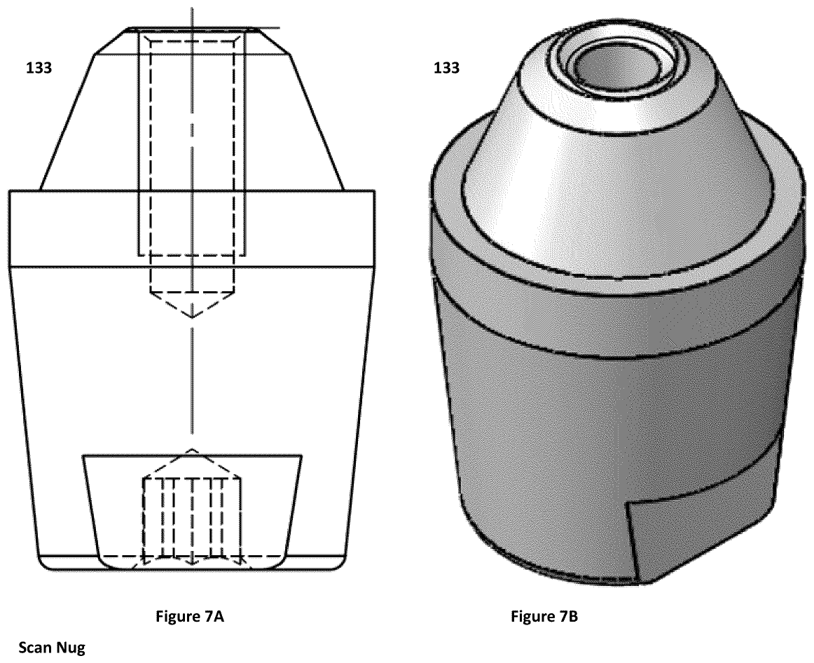

FIG. 7A illustrates a side view of a diagram of internal surfaces of an embodiment of a scan nug 133 with a cavity to receive a screw from a universal scan body 115. FIG. 7B illustrates a perspective view of external surfaces of an embodiment of a scan nug 133 that has notches/indents on opposite sides to aid in establishing points of commonality to locate in a scan image.

During the restoration phase, the doctor uses the STV tray 110, the universal scan bodies 115, and then the scan nug 133.

Once the tissue has healed, the doctor can remove the temporary denture and place universal scan bodies 115 unto the multiple unit analog that was installed in the surgery stage. The universal scan bodies 115, during restoration, sit on top of the multiple unit abutment as follows i) the doctor removes the temporary denture—the dental pieces the patient was wearing for a few months while the tissue was healing, ii) if needed, the doctor torques each multiple unit abutment/analog implanted in the bone, iii) the doctor place universal scan bodies 115 unto the multiple unit abutment/analog. Thus, the universal scan bodies 115 directly connects unto the multiple unit abutment/analog, during restoration, rather than a suture cap 118 being located between the two components during surgery. Hand torque each universal scan body 115 and verify that the universal scan body 115 does not move in place, which, by extension, gets the exact location and angles of the connected multiple unit abutment fused to the bone of the patient. Next, the doctor installs the empty STV tray 110 and verifies that all of the scan bodies 115 fit within the U-shaped opening between the frame of the STV tray 110 and extend past the height of the walls of the STV tray 110. The doctor can perform an intraoral scan. Note, the suture cap is larger than original manufacturer protective caps.

Next, the doctor removes the STV tray 110 from the mouth and inserts dental putty. The doctor takes the dental putty material and puts the dental putty material into the STV tray 110. The dental putty fills in the area of the U-shaped opening in between the frame of the dental tray. The holes built into the walls of the frame of the STV allow the dental putty to pass through those holes, and then lock in and hold the putty in place, supported and held in place by the rest of the frame. The doctor will then push the STV tray 110 through the scan bodies 115 and remove excess material. Thus, the doctor places the STV tray 110 with the putty material into the patient's mouth and presses the STV tray 110 and putty material into place around the installed scan bodies 115, which will extend past both the STV tray 110 and its putty material. The doctor can allow the dental putty to harden. Now the STV tray 110 will be ready for the IOS scan, and implant position indicated by the universal scan bodies 115. The doctor can start the scan free of blood and loose tissue with the dental putty in place in the STV tray 110 and the universal skin bodies within the dental putty in place.

Next, the doctor can unscrew universal scan bodies 115 in the dental impression connected to the multiple unit analog and then remove the STV tray 110 with hardened putty and universal scan bodies 115 in the dental impression. Thus, after the scan, the doctor can remove the screw from each of the scan bodies 115 mating them with their corresponding multiple unit abutment. After everything is unscrewed, then remove the STV tray 110 with the putty locked in place and the scan bodies 115 locked within the hardened putty within the frame of the STV tray 110, from the patient's mouth. The doctor can check whether the scan bodies 115 were seated properly on the multiple unit abutments by no material tissue or putty material being on a surface area where that scan body 115 seated against the multiple unit abutment that it mated to.

Next, the doctor can rinse the removed STV tray 110. The doctor can install the scan nug 133s and screw them in place. The doctor can use the scan nug 133 and a screw to connect to the scan bodies 115 locked into the putty material forming the dental impression. The scan nug 133 along with the dental impression captured in the hardened dental putty allows the capture of the tissue impression. The doctor can scan the STV tray 110 with its putty, the scan bodies 115, and the scan nug 133s all the way around the dental impression to create the image of a full temporary scan, which will be used to create the final dental implants.

The doctor scans the tissue impression with the scan nug 133s (note that the tissue is under compression which provides an accurate gingiva adaptation. The universal scan body 115 is on one side of the hardened dental impression in the STV tray 110 and the scan nug 133 is on the other side of the hardened dental impression in the STV tray 110. In the software library, those two components are merged into one common piece to be able to make accurate determinations on alignment of the implant, because the technician merging scans and making determinations from the scans can choose from both ends, as well as an amount of tissue in the mouth.

Note, a screw is used to mate components together rather than a threaded bolt, which could lock up due to the presence of blood or tissue in the threads of the threaded bolts. Note, the components are made from titanium in order to be able to reuse many of these components and allow them to be autoclaved so that the so that these components can be reused over and over and over again, without dimensional changes on the parts, when taking different impressions for the implants. Also, the component parts mate/are held together by screws and the titanium material will not wear when the same part is reused over many surgeries and procedures. In the surgery stage, the universal scan body 115 mates through a screw connection with the scan bullet 122. In the restoration stage, the universal scan body 115 mates through a screw connection with the scan nug 133.

Lastly, the laboratory can deliver the PMMA and/or final dental restoration based upon the restorative scan.

One of the key advantages of the full arch 3D digital facial scanning workflow ecosystem for surgery and restoration of dental implants is its ability to streamline the entire process from pre-surgery to the final prosthesis in less than five appointments. By significantly reducing the number of appointments and chair time by 70%, the full arch 3D digital facial scanning workflow ecosystem for surgery and restoration of dental implants saves valuable time for both doctors and patients.

With the full arch 3D digital facial scanning workflow ecosystem for surgery and restoration of dental implants, doctors no longer need to worry about ill-fitting prosthesis, uneven smiles, or aesthetic inconsistencies. The full arch 3D digital facial scanning workflow ecosystem for surgery and restoration of dental implants ensures precise alignment between implants and the prosthesis, guaranteeing optimal results and eliminating any aesthetic concerns.

The set of parts and a sequence to use the parts with multiple use and purposes of all the components, both during surgery and then the restorative process. The full arch 3D digital facial scanning workflow ecosystem for surgery and restoration of dental implants uses the same STV tray 110, the same putty, the same universal scan bodies 115 mated to another component from the set of parts, and the same procedures in the surgery stage and the restoration stage.

In another example method for the full arch 3D digital facial scanning workflow ecosystem can be below. Please note more or less steps may be performed than the shown steps. In addition, where logically possible, the steps may be performed in an order than the example listed order. The example method for the full arch 3D digital facial scanning workflow ecosystem may include several phases/stages—the pre-surgery process of obtaining a facial scan of the patient's current anatomical state, the surgical placement of the biocompatible implant and scanning of the implant, and the restoration stage of attachment of the restorative teeth to the implant (e.g., connecting the implant crown to the dental implant). The restoration stage occurs several months after the tissue that was sutured during the surgery stage is healed (and optionally the implant is completely fused to the bone). The example method for the full arch 3D digital facial scanning workflow ecosystem may include in the pre-surgery stage, initial scanning a patient (e.g., 3D facial scan) to obtain their intra oral details, bite shape, and other anatomical condition, merging the scanned DICOM file/IOS files/facial scan file, designing pre-smile, reviewing pre-smile. The example method for the full arch 3D digital facial scanning workflow ecosystem may include in the next stage, performing surgery and 3D patient full arch digital workflow, merging surgical scan files to approved pre-smile design, fabrication of screw retained temporary, sending surgical scanned files back to doctor to print temporary or ship temporary, receiving fabricated temporary and screw it in patient's mouth, performing an intraoral scanners (IOS) scan to capture an optical impression. The example method for the full arch 3D digital facial scanning workflow ecosystem may include in the restoration stage, —performing a facial scan, merging new IOS files, fabrication of polymethyl methacrylate (PMMA) dental implant replacement teeth and/or final restoration, shipping final restoration, and PMMA or Final Delivery.

As discussed, the full arch 3D digital facial scanning workflow ecosystem is an example dental process that can use the techniques discussed herein but many other procedures can also use portions of these techniques.

### Network

An example network environment can be used to assist with the workflow. A number of electronic systems and devices can communicate with each other in a network environment in accordance with the embodiments discussed herein. The network environment has a communications network. The network can include one or more networks selected from an optical network, a cellular network, the Internet, a Local Area Network (“LAN”), a Wide Area Network (“WAN”), a satellite network, a fiber network, a cable network, and combinations thereof. In some embodiments, the communications network is the Internet. There may be many server computing systems and many client computing systems connected to each other via the communications network.

The communications network can connect one or more server computing systems selected from at least a first server computing system and a second server computing system to each other and to at least one or more client computing systems as well. The server computing systems can each optionally include organized data structures such as databases. The 3D digital scanner can communicate with a number of these different network components throughout the workflow.

The at least one or more client computing systems can be selected from a first mobile computing device (e.g., smartphone with an Android-based operating system), a second mobile computing device (e.g., smartphone with an iOS-based operating system), a first wearable electronic device (e.g., a smartwatch), a first portable computer (e.g., laptop computer), a third mobile computing device or second portable computer (e.g., tablet with an Android- or iOS-based operating system), a first electric personal transport vehicle, a second electric personal transport vehicle, and the like. The client computing system can include, for example, the software application or the hardware-based system in which may be able exchange communications with the 3D digital scanner. Each of the one or more client computing systems can have one or more firewalls to protect data integrity.

It should be appreciated that the use of the terms “client computing system” and “server computing system” is intended to indicate the system that generally initiates a communication and the system that generally responds to the communication. For example, a client computing system can generally initiate a communication and a server computing system generally responds to the communication. No hierarchy is implied unless explicitly stated. Both functions can be in a single communicating system or device, in which case, the client-server and server-client relationship can be viewed as peer-to-peer. Thus, if the first portable computer (e.g., the client computing system) and the server computing system can both initiate and respond to communications, their communications can be viewed as peer-to-peer. Additionally, the server computing systems include circuitry and software enabling communication with each other across the network.

### Computing Systems

One or more computing devices can be used in the 3D patient full arch digital workflow discussed herein. A computing system can be, wholly or partially, part of one or more of the server or client computing devices in accordance with some embodiments. The computing systems are specifically configured and adapted to carry out the processes discussed herein. Components of the computing system can include, but are not limited to, a processing unit having one or more processing cores, a system memory, and a system bus that couples various system components including the system memory to the processing unit. The system bus may be any of several types of bus structures selected from a memory bus or memory controller, a peripheral bus, and a local bus using any of a variety of bus architectures.

The computing system typically includes a variety of computing machine-readable media. Computing machine-readable media can be any available media that can be accessed by computing system and includes both volatile and nonvolatile media, and removable and non-removable media. By way of example, and not limitation, computing machine-readable media use includes storage of information, such as computer-readable instructions, data structures, other executable software or other data. Computer-storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information and which can be accessed by the computing device 900. Transitory media such as wireless channels are not included in the machine-readable media. Communication media typically embody computer readable instructions, data structures, other executable software, or other transport mechanism and includes any information delivery media.

The system memory includes computer storage media in the form of volatile and/or nonvolatile memory such as read only memory (ROM) and random access memory (RAM). A basic input/output system (BIOS) containing the basic routines that help to transfer information between elements within the computing system, such as during start-up, is typically stored in ROM. RAM typically contains data and/or software that are immediately accessible to and/or presently being operated on by the processing unit. By way of example, and not limitation, the RAM can include a portion of the operating system, application programs, other executable software, and program data.

The drives and their associated computer storage media discussed above, provide storage of computer readable instructions, data structures, other executable software and other data for the computing system.

A user may enter commands and information into the computing system through input devices such as a keyboard, touchscreen, or software or hardware input buttons, a microphone, a pointing device and/or scrolling input component, such as a mouse, trackball or touch pad. The microphone can cooperate with speech recognition software. These and other input devices are often connected to the processing unit through a user input interface that is coupled to the system bus, but can be connected by other interface and bus structures, such as a parallel port, game port, or a universal serial bus (USB). A display monitor or other type of display screen device is also connected to the system bus via an interface, such as a display interface. In addition to the monitor, computing devices may also include other peripheral output devices such as speakers, a vibrator, lights, and other output devices, which may be connected through an output peripheral interface.

The computing system can operate in a networked environment using logical connections to one or more remote computers/client devices, such as a remote computing system. The logical connections can include a personal area network (“PAN”) (e.g., Bluetooth®), a local area network (“LAN”) (e.g., Wi-Fi), and a wide area network (“WAN”) (e.g., cellular network), but may also include other networks. Such networking environments are commonplace in offices, enterprise-wide computer networks, intranets and the Internet. A browser application may be resident on the computing device and stored in the memory.

It should be noted that the present design can be carried out on a computing system. However, the present design can be carried out on a server, a computing device devoted to message handling, or on a distributed system in which different portions of the present design are carried out on different parts of the distributed computing system.

A wireless communication module can employ a Wireless Application Protocol to establish a wireless communication channel. The wireless communication module can implement a wireless networking standard.

In some embodiments, software used to facilitate algorithms discussed herein can be embodied onto a non-transitory machine-readable medium. A machine-readable medium includes any mechanism that stores information in a form readable by a machine (e.g., a computer). For example, a non-transitory machine-readable medium can include read only memory (ROM); random access memory (RAM); magnetic disk storage media; optical storage media; flash memory devices; Digital Versatile Disc (DVD's), EPROMs, EEPROMs, FLASH memory, magnetic or optical cards, or any type of media suitable for storing electronic instructions.

Note, an application described herein includes but is not limited to software applications, mobile apps, and programs that are part of an operating system application. Some portions of this description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as C, C+, or other similar languages. Also, an algorithm can be implemented with lines of code in software, configured logic gates in software, or a combination of both. In an embodiment, the logic consists of electronic circuits that follow the rules of Boolean Logic, software that contain patterns of instructions, or any combination of both. A module can be implemented in electronic hardware, software instruction cooperating with one or more memories for storage and one of more processors for execution, and a combination of electronic hardware circuitry cooperating with software.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

Many functions performed by electronic hardware components can be duplicated by software emulation. Thus, a software program written to accomplish those same functions can emulate the functionality of the hardware components in input-output circuitry.

While the foregoing design and embodiments thereof have been provided in considerable detail, it is not the intention of the applicant(s) for the design and embodiments provided herein to be limiting. Additional adaptations and/or modifications are possible, and, in broader aspects, these adaptations and/or modifications are also encompassed. Accordingly, departures may be made from the foregoing design and embodiments without departing from the scope afforded by the following claims, which scope is only limited by the claims when appropriately construed.

1. An apparatus, comprising:
a STV tray configured to have a frame with a U-shaped opening resembling a bite shape of the teeth in a patient's mouth, where the U-shaped opening is located in the frame of the STV tray where the teeth of the patient should be located,
where the frame has lips and walls to structurally form and support dental putty inserted into the U-shaped in the frame and secure the dental putty in place when removing the STV tray from the patient's mouth,
where the STV tray in cooperation with the dental putty and one or more universal scan bodies is engineered to keep blood, debris, and moisture out of a scanning field of an intraoral scanner while capturing a dental impression of a dental implant's position and an accurate tissue topology adaptation under compression.

2. The apparatus of claim 1, where the STV tray has a U-shaped frame to receive the dental putty material to capture the dental impression.

3. The apparatus of claim 1, where the STV tray is configured to cooperate with the universal scan bodies and the dental putty to provide a tool for i) a 3D digital facial scan, ii) a collection of a tissue impression of the tissue topology under compression, as well as iii) a verification of acceptable locations for the dental implants, all in one component, which is used during a surgery stage for the dental implants, as well as a restoration stage for the dental implants.

4. The apparatus of claim 1, where a first universal scan body is configured to mate to multiple other components in a set of parts used in a full arch 3D digital facial scanning workflow consisting of 1) a scan nug, 2) a multi-unit abutment, 3) an orientation scan marker, and 4) a scan bullet, depending on a procedure being performed in a surgery stage for the dental implants or a restoration stage for the dental implants in the full arch 3D digital facial scanning workflow.

5. The apparatus of claim 1, where a first universal scan body is configured to have a hollow interior to allow threads of a screw to pass through the first universal scan body and then screw into a cavity in a top of 1) a scan nug, 2) a multi-unit abutment, 3) an orientation scan marker, and 4) a scan bullet.

6. The apparatus of claim 1, where a first universal scan body is configured to have multiple retention prongs that are in a middle portion of its body that lock the first universal scan body into the dental putty to prevent the first universal scan body from rotating once the dental putty hardens in the STV tray, and where the STV tray is configured to have two or more distinct shapes in an exterior of a top portion of the STV tray to be able to pick out points of commonality to stitch different scans together.

7. The apparatus of claim 1, where an external surface of the one or more universal scan bodies are sand blasted to ensure the external surface is not highly reflective during a 3D facial scan, when the high reflectivity can cause issues with an inter oral scanner interpreting what is being scanned when making its 3D model, and thus, the external surface being sand blasted is configured to allow the 3D facial scan to accurately interpret a presence and location of the one or more universal scan bodies in the 3D facial scan.

8. The apparatus of claim 1, further comprising:
a scan bullet configured to receive a screw passing through a first universal scan body, where the first universal scan body is locked in place in the dental putty in the frame of the STV tray that has been removed from the patient's mouth, where the scan bullet is placed in an implant site in the dental impression captured by the universal scan body locked into position in the dental putty that has hardened, where the first universal scan body is on one side of the dental putty impression and the scan bullet is on the other side of the dental putty impression, which is locked into the STV tray.

9. The apparatus of claim 1, further comprising:
a scan bullet along with the dental impression captured in the dental putty that has hardened allows a capture of a tissue scan of the tissue topology under compression, where the topography of the tissue around the dental implant is captured under compression, without all of the blood and debris present during surgery.

10. The apparatus of claim 2, where the lips and walls of the U-shaped frame of the STV tray are configured to provide a surface for the dental putty to adhere to as well as multiple holes in the walls to allow the dental putty to fill into these holes, which allows the dental putty material to lock into the frame of the STV tray during removal of the STV tray from the patient's mouth as well as when subsequent scans occur on the STV tray with the universal scan bodies, where the STV tray with the dental putty is configured to give an ability to capture the dental impression which can then be removed from the mouth to get a 3D digital facial scanning outside a bloody environment of the mouth during surgery.

11. A method for performing a full arch 3D digital facial scanning workflow, comprising:
providing a STV tray to have a frame with a U-shaped opening resembling a bite shape of the teeth in a patient's mouth, where the U-shaped opening is located in the frame of the STV tray where the teeth of the patient should be located,
providing the frame with lips and walls to structurally form and support dental putty inserted into the U-shaped opening in the frame as well as secure the dental putty in place when removing the STV tray from the patient's mouth, and
providing the STV tray in cooperation with the dental putty and one or more universal scan bodies to keep blood, debris, and moisture out of a scanning field of an intraoral scanner while capturing a dental impression of each dental implant's position and an accurate tissue topology adaptation under compression.

12. The method of claim 11, further comprising:
providing the STV tray with a U-shaped frame to receive the dental putty material to capture the dental impression.

13. The method of claim 11, further comprising:
providing the STV tray to cooperate with the universal scan bodies and the dental putty to provide a tool for i) a 3D digital facial scan, ii) a collection of a tissue impression of the tissue topology under compression, as well as iii) a verification of acceptable locations for the dental implants, all in one component, which is used during a surgery stage for the dental implants as well as a restoration stage for the dental implants.

14. The method of claim 11, further comprising:
providing a first universal scan body to mate to multiple other components in a set of parts used in the full arch 3D digital facial scanning workflow consisting of 1) a scan nug, 2) a multi-unit abutment, 3) an orientation scan marker, and 4) a scan bullet, depending on a procedure being performed in a surgery stage for the dental implants or a restoration stage for the dental implants in the full arch 3D digital facial scanning workflow.

15. The method of claim 11, further comprising:
providing a first universal scan body to have a hollow interior to allow threads of a screw to pass through the first universal scan body and then screw into a cavity in a top of 1) a scan nug, 2) a multi-unit abutment, 3) an orientation scan marker, and 4) a scan bullet.

16. The method of claim 11, further comprising:
providing a first universal scan body to have multiple retention prongs that are in a middle portion of its body that lock the first universal scan body into the dental putty to prevent the first universal scan body from rotating once the dental putty hardens in the STV tray, and
providing the STV tray with two or more distinct shapes in an exterior of a top portion of the STV tray to be able to pick out points of commonality to stitch different scans together.

17. The method of claim 11, further comprising:
providing an external surface of the one or more universal scan bodies that were sand blasted to ensure the external surface is not highly reflective during a 3D facial scan, when the high reflectivity can cause issues with an inter oral scanner interpreting what is being scanned when making its 3D model, and thus, the external surface being sand blasted allows the 3D facial scan to accurately interpret a presence and location of the one or more universal scan bodies in the 3D facial scan.

18. The method of claim 11, further comprising:
providing a scan bullet to receive a screw passing through a first universal scan body, where the first universal scan body is locked in place in the dental putty in the frame of the STV tray that has been removed from the patient's mouth, and
providing the scan bullet to be placed in an implant site in the dental impression captured by the universal scan body locked into position in the dental putty that has hardened, where the first universal scan body is on one side of the accurate dental putty impression and the scan bullet is on the other side of the dental putty impression, which is locked into the STV tray.

19. The method of claim 11, further comprising:
providing a scan bullet along with the dental impression captured in the dental putty that has hardened to allow a capture of a tissue scan of the tissue topology under compression, where the topography of the tissue around the dental implant is captured under compression, without all of the blood and debris present during surgery.

20. The method of claim 12, further comprising:
providing the lips and walls of the U-shaped frame of the STV tray to provide a surface for the dental putty to adhere to as well as multiple holes in the walls to allow the dental putty to fill into these holes, which allows the dental putty material to lock into the frame of the STV tray during removal of the STV tray from the patient's mouth as well as when subsequent scans occur on the STV tray with the universal scan bodies, and
providing the STV tray with the dental putty to give an ability to capture the dental impression which can then be removed from the mouth to get a 3D digital facial scanning outside a bloody environment of the mouth during surgery.
